(19) United States
(12) Patent Application Publication
(10) Pub. No.: US 2022/0317926 A1
(43) Pub. Date: Oct. 6, 2022

(54) APPROACH FOR ENFORCING ORDERING BETWEEN MEMORY-CENTRIC AND CORE-CENTRIC MEMORY OPERATIONS

(71) Applicant: Advanced Micro Devices, Inc., Santa Clara, CA (US)

(72) Inventors: Shaizeen Aga, Santa Clara, CA (US); Nuwan Jayasena, Santa Clara, CA (US); Johnathan Alsop, Bellevue, WA (US)

(21) Appl. No.: 17/219,446

(22) Filed: Mar. 31, 2021

(51) Int. Cl. G06F 3/06

(52) U.S. Cl. CPC G06F 3/0659; G06F 3/0604; G06F 3/0673

(57) ABSTRACT

Ordering between memory-centric memory operations, referred to hereinafter as “MC-Mem-Ops,” and core-centric memory operations, referred to hereinafter as “CC-Mem-Ops,” is enforced using inter-centric fences, referred to hereinafter as an “IC-fences.” IC-fences are implemented by an ordering primitive or ordering instruction, that cause a memory controller, a cache controller, etc., to enforce ordering of MC-Mem-Ops and CC-Mem-Ops throughout the memory pipeline and at the memory controller by not reordering MC-Mem-Ops (or sometimes CC-Mem-Ops) that arrive before the IC-fence to after the IC-fence. Processing of an IC-fence also causes the memory controller to issue an ordering acknowledgment to the thread that issued the IC-fence instruction. IC-fences are tracked at the core and designated as complete when the ordering acknowledgment is received. Embodiments include a completion level-specific cache flush operation which, when used with an IC-fence, provides proper ordering between cached CC-Mem-Ops and MC-Mem-ops with reduced data transfer and completion times.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

Contemporary processors employ performance optimizations that can cause out-of-order execution of memory operations, such as loads, stores and read-modify-writes, which can be problematic in multi-threaded or multi-processor/multi-core implementations. In a simple example, a set of instructions may specify that a first thread updates a value stored at a memory location and afterward a second thread uses the updated value, for example, in a calculation. If executed in the order expected based upon the ordering of the instructions, the first thread would update the value stored at the memory location before the second thread retrieves and uses the value stored at the memory location. However, performance optimizations may reorder the memory accesses so that the second thread uses the value stored at the memory location before the value has been updated by the first thread, causing an unexpected and incorrect result.

To address this issue, processors support a memory barrier or a memory fence, also known simply as a fence, implemented by a fence instruction, which causes processors to enforce an ordering constraint on memory operations issued before and after the fence instruction. In the above example, fence instructions can be used to ensure that the access to the memory location by the second thread is not reordered prior to the access to the memory location by the first thread, preserving the intended sequence. These fences are often implemented by blocking subsequent memory requests until all prior memory requests have acknowledged that they have reached a “coherence point”—that is, a level in the memory hierarchy that is shared by communicating threads, and below which ordering between accesses to the same address are preserved. Such memory operations and fences are core-centric in that they are tracked at the processor and the ordering is enforced at the processor.

As computing throughput scales faster than memory bandwidth, various techniques have been developed to keep the growing computing capacity fed with data. Processing In Memory (PIM) incorporates processing capability within memory modules so that tasks can be processed directly within the memory modules. In the context of Dynamic Random-Access Memory (DRAM), an example PIM configuration includes vector compute elements and local registers. The vector compute elements and the local registers allow a memory module to perform some computations locally, such as arithmetic computations. This allows a memory controller to trigger local computations at multiple memory modules in parallel without requiring data movement across the memory module interface, which can greatly improve performance, particularly for data-intensive workloads.

Fences can be used with compute elements in memory in the same manner as processors to enforce an ordering constraint on memory operations performed by the in-memory compute elements. Such memory operations and fences are memory-centric in that they are tracked at the in-memory compute elements and the ordering is enforced at the in-memory compute elements.

One of the technical problems with the aforementioned fences is that while they are effective for separately enforcing ordering constraints for core-centric and memory-centric memory operations, respectively, they are insufficient to enforce ordering between core-centric and memory-centric memory operations. Core-centric fences are insufficient for memory-centric memory operations, which may require that ordering is preserved beyond the coherence point, even if they don't target the same address because a memory-centric request may access multiple addresses as well as near-memory registers, and any requests that conflict must be ordered. Memory-centric fences are insufficient because they only ensure that memory-centric memory operations and un-cached core-centric memory operations that are bound to complete at the same memory-level, e.g., memory-side caches or in-memory compute units, are delivered in order at the memory level that is the point of completion. Cores with threads issuing memory-centric memory operations need to be aware when the memory-centric memory operations have been scheduled at the memory level that is the point of completion to allow safe commit of subsequent core-centric memory operations that need to see the results of the memory-centric memory operations. However, in-memory compute units (even those in memory side caches) might not send acknowledgments to cores in the same manner as traditional core-centric memory operations, leaving cores unaware of the current status of memory-centric memory operations. There is therefore a need for a technical solution to the technical problem of how to enforce ordering between memory-centric memory operations and core-centric memory operations.

### BRIEF DESCRIPTION OF THE DRAWINGS

Embodiments are depicted by way of example, and not by way of limitation, in the figures of the accompanying drawings and in which like reference numerals refer to similar elements.

FIG. 1A depicts example pseudo code implemented by two threads in a processor.

FIG. 1B depicts example pseudo code that includes core-centric fences to ensure correct execution.

FIG. 1C depicts example pseudo code that includes memory-centric fences to ensure correct execution.

FIG. 1D depicts an IC-fence that has been added to the instructions for Thread A.

FIG. 2A depicts using an IC-fence to enforce ordering between memory-centric memory operations and core-centric memory operations.

FIG. 2B depicts using an IC-fence to enforce ordering between core-centric memory operations and memory-centric memory operations.

FIG. 2C depicts using an IC-fence to enforce ordering between memory-centric memory operations and memory-centric memory operations.

FIG. 2D depicts using an CC-fences to enforce ordering between core-centric memory operations and core-centric memory operations.

FIG. 3 is a flow diagram that depicts an approach for enforcing ordering between memory-centric memory operations and core-centric memory operations using IC-fences.

### DETAILED DESCRIPTION

In the following description, for the purposes of explanation, numerous specific details are set forth in order to provide a thorough understanding of the embodiments. It will be apparent, however, to one skilled in the art that the embodiments may be practiced without these specific details. In other instances, well-known structures and devices are shown in block diagram form in order to avoid unnecessarily obscuring the embodiments.

I. Overview

II. IC-Fence Introduction

III. IC-Fence Implementation
A. Ordering Tokens
B. Level-Specific Cache Flushes

### I. Overview

A technical solution to the technical problem of the inability to enforce ordering between memory-centric memory operations, referred to hereinafter as “MC-Mem-Ops,” and core-centric memory operations, referred to hereinafter as “CC-Mem-Ops,” uses inter-centric fences, referred to hereinafter as an “IC-fences.” IC-fences are implemented by an ordering primitive, also referred to herein as an ordering instruction, that cause a memory controller, a cache controller, etc., referred to herein as a “memory controller,” to enforce ordering of MC-Mem-Ops and CC-Mem-Ops throughout the memory pipeline and at a memory controller by not reordering MC-Mem-Ops (or sometimes CC-Mem-Ops) that arrive before the IC-fence to after the IC-fence. IC-fences also include a confirmation mechanism that involves the memory controller issuing an ordering acknowledgment to the thread that issued the IC-fence instruction. IC-fences are tracked at the core and designated as complete when the ordering acknowledgment is received from the memory controller(s). The technical solution is applicable to any type of processor with any number of cores and any type of memory controller.

The technical solution accommodates mixing of CC-Mem-Op and MC-Mem-Op code regions at a finer granularity than using only core-centric and memory centric fences while preserving correctness. This allows memory-side processing components to be used more effectively without requiring completion acknowledgments to be sent to core threads for each MC-Mem-Op, which improves efficiency and reduces bus traffic. Embodiments include a completion level-specific cache flush operation that provides proper ordering between cached CC-Mem-Ops and MC-Mem-ops with reduced data transfer and completion times relative to conventional cache flushes. As used herein, the term “completion level” refers to a point in the memory system shared by communicating threads, and below which all required CC-MC orderings are guaranteed to be preserved, e.g., orderings between MC accesses and CC accesses that conflict with the addresses targeted by the memory controller.

### II. IC-Fence Introduction

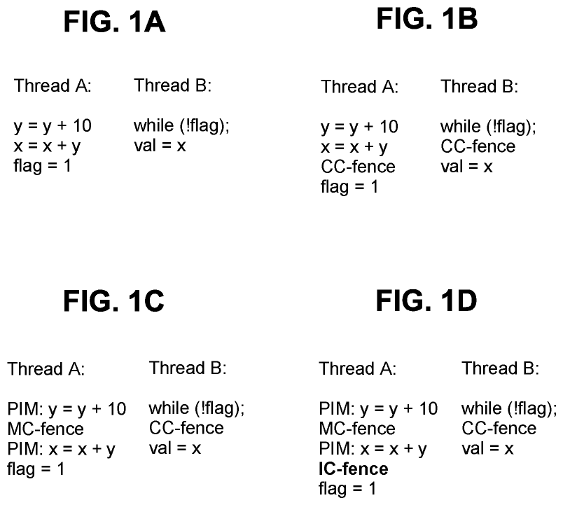

FIG. 1A depicts example pseudo code implemented by two threads in a processor. In this example, Thread A updates the value of y, uses the updated value of y to update the value of x, and then sets a flag to a value of 1 to indicate that the value of x has been updated and is ready to be used. Assuming that the initial value of the flag is 0, Thread B is expected to spin until the flag is set to the value of 1 by Thread A. Thread B then retrieves the updated value of x.

Performance optimizations for the processor may reorder the memory accesses and cause Thread B to retrieve an old value of x. For example, a performance optimization may cause the “val=x” instruction of Thread B to be executed prior to the “while (!flag);” instruction which, depending upon when Thread A updated the value of x, may cause Thread B to retrieve an old value of x.

FIG. 1B depicts example pseudo code that includes core-centric fences (CC-fences) to ensure correct execution. The pseudo code of FIG. 1B is the same as in FIG. 1A, except a CC-fence has been added in Thread A after the “x=x+y” instruction and another CC-fence has been added in Thread B after the “while (!flag);” instruction. The CC-fence in Thread A prevents the setting of the flag (“flag=1”) from being reordered prior to the CC-fence. This ensures that the write to the flag by Thread A is only made visible to other threads at a point when the updates to x and y made by Thread A are guaranteed to be visible to other threads, specifically Thread B in the example. Similarly, the CC-fence in Thread B ensures that the reading of the value of x (“val=x”) is not reordered prior to the CC-fence. This ensures that the reading of the value of x occurs after the read of the set flag.

FIG. 1C depicts example pseudo code that includes memory-centric fences (MC-fences) to ensure correct execution. The pseudo code of FIG. 1C is the same as in FIG. 1A, except the computations of y and x have been offloaded to PIM units in memory using MC-Mem-Ops to reduce the computational burdens on the core processor and reduce memory bus traffic. In certain situations, however, this leads to a new ordering requirement of ensuring that the MC-Mem-Ops (and any un-cached CC-Mem-Ops) are executed in order. In the example depicted in FIG. 1C, the PIM update to y has to precede the PIM update to x to ensure that x is the correct value when read by Thread B.

As CC-fences are inadequate to enforce ordering at memory computational units, an MC-fence implemented by a memory centric ordering primitive (MC-OPrim) that is inserted into the code of Thread A between the “PIM: y=y+10” instruction and the “PIM: x=x+y” instruction. Memory centric ordering primitives are described in U.S. patent application Ser. No. 16/808,346 entitled “Lightweight Memory Ordering Primitives,” filed on Mar. 3, 2020, the entire contents of which is incorporated by reference herein in its entirety for all purposes. The MC-OPrim flows down the memory pipe from the core to the memory to maintain ordering en route to memory. The MC-fence between the PIM update to y and the PIM update to x ensures that the instructions are properly ordered during execution at memory. As this ordering is enforced at memory, the MC-OPrim follows the same “fire and forget” semantics of MC-Mem-Ops because it is not tracked by the core and allows the core to process other instructions. As in the example of FIG. 1B, in FIG. 1C the CC-fence in Thread B ensures that the reading of the value of x (“val=x”) is not reordered prior to the CC-fence.

The example of FIG. 1C shows that even with the availability of CC-fences and MC-fences, intermixing of CC-Mem-Ops and MC-Mem-Ops is challenging as neither of these existing solutions is adequate to provide the required ordering. Specifically, the updates to y and x have to be completed, or at least appear to be completed, before the CC-Mem-Op in Thread A for updating the value of the flag to 1, i.e., the instruction “flag=1,” is made visible to Thread B. CC-fences are inadequate for MC-Mem-Ops whose completion level is beyond the coherence point because they do not enforce ordering of MC-Mem-Ops beyond the coherence point. MC-fences are inadequate because they only ensure that MC-Mem-Ops and un-cached CC-Mem-Ops that are bound to complete at the same memory-level are delivered in order at the memory level that is the point of completion.

In FIG. 1C, the core needs to be aware when the MC-Mem-Ops to update the values of y and x have been scheduled at the memory controller at the point of completion to allow a safe commit of the “flag=1” instruction of Thread A. However, the PIM execution unit updating the values of y and x does not send acknowledgments to the core executing Thread A in the same manner as traditional CC-Mem-Ops, so the core is unaware of the status of these MC-Mem-Ops and does not know when they have been scheduled. These limitations require that the code regions of Thread A and Thread B be implemented at a coarser granularity.

According to an embodiment, this technical problem is addressed by a technical solution that includes the use of IC-fences to provide ordering between CC-Mem-Ops and MC-Mem-Ops. FIG. 1D depicts an IC-fence that has been added to the instructions for Thread A. More specifically, an IC-fence is added to the instructions of Thread A before the update of the flag to 1, i.e., before the “flag=1” instruction. The IC-fence is implemented by an ordering primitive or ordering instruction that enforces ordering of MC-Mem-Ops at the memory controller. Processing of an IC-fence also causes the memory controller to issue an acknowledgment or confirmation to the thread that issued the IC-fence instruction. In the example of FIG. 1D, Thread A receives a confirmation that the MC-Mem-Ops preceding the IC-fence to update the values of y and x via the “PIM: y=y+10” and “PIM: x=x+y” instructions, respectively, have been scheduled by the corresponding memory controller. Thread A waits to process further instructions, at least on a non-speculative basis, until the confirmation is received. This allows mixing of CC-Mem-Op and MC-Mem-Op instructions at a finer granularity than using only core-centric and memory centric fences while preserving correctness, without requiring completion acknowledgments to be sent to core threads for each MC-Mem-Op.

### III. IC-Fence Implementation

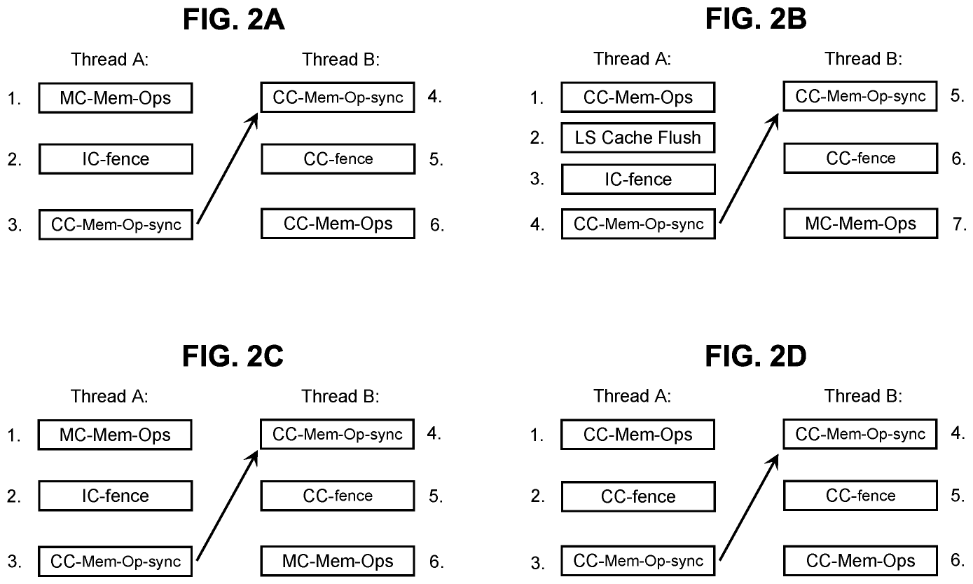

FIGS. 2A-2D depict the four possible inter-centric orderings that can arise between core-centric memory operations and memory-centric memory operations, and vice versa. In these examples, MC-Mem-Ops refers to one or more memory-centric memory operations and CC-Mem-Ops refers to one or more core-centric memory operations of any number and type.

In FIGS. 2A and 2C, ordering between MC-Mem-Ops and CC-Mem-Ops and between MC-Mem-Ops and MC-Mem-Ops, respectively, is accomplished using an IC-fence in Thread A and a CC-fence in Thread B. In these examples the IC-fence ensures that the issuing core receives an acknowledgment from the memory controller that the MC-Mem-Ops have been scheduled before proceeding to the next memory operations, at least on a non-speculative basis.

In FIG. 2B ordering between CC-Mem-Ops and MC-Mem-Ops is accomplished using a level-specific (LS) cache flush, which is described in more detail hereinafter, an IC-fence and a CC-fence. Finally, in FIG. 2D, ordering between CC-Mem-Ops and CC-Mem-Ops is accomplished using CC-fences, which are sufficient for this scenario because the core is aware of when the first set of CC-Mem-Ops has been scheduled at the memory controller and can then proceed with the second set of CC-Mem-Ops. CC-fences are also sufficient to ensure proper ordering of MC-Mem-Ops whose completion level is before the coherence point because such operations can be configured to send acknowledgements to the core at low cost. For example, the MC-Mem-Ops may be performed in cache before the coherence point.

It is presumed that the inter-thread synchronization (CC-Mem-Op-sync) in steps 3 and 4 of FIGS. 2A, 2C, 2D and steps 4 and 5 of FIG. 2B is accomplished using one or more core-centric memory operations. Inter-thread synchronization may be implemented by any mechanism that allows one thread to signal another thread that it has completed a set of memory operations. For example, in the CC-Mem-Op-Sync of step 3 of FIG. 2A, Thread A signals Thread B that it has completed the MC-Mem-Ops in step 1. One non-limiting example of a CC-Mem-Op-sync is the use of a flag as depicted in FIGS. 1A-1D and previously described herein, i.e., setting a flag in Thread A, and reading the flag in Thread B.

IC-fences are described herein in the context of being implemented as an ordering primitive or instruction for purposes of explanation, but embodiments are not limited to this example and an IC-fence may be implemented by a new semantic attached to an existing synchronization instruction, such as memfence, waitcnt, atomic LD/ST/RMW, etc.

An IC-fence instruction has an associated completion level that is beyond the coherence point, e.g., at memory-side caches, in-DRAM PIM, etc. The completion level may be specified, for example, an instruction parameter value. A completion level may be specified via an alphanumeric value, code, etc. A software developer may specify the completion level for an IC-fence instruction to be the completion level for preceding memory operations that need to be ordered. For example, in FIG. 1D, the IC-fence instruction may specify a completion level that is the completion level of the preceding two PIM commands to update y and x, respectively, e.g., a memory-side cache or DRAM.

According to an embodiment, each IC-fence instruction is tracked at the issuing core until one or more ordering acknowledgements are received at the issuing core confirming that memory operations preceding the IC-fence instruction have been scheduled at a completion-level associated with the IC-fence instruction. The IC-fence is then considered to be completed and is designated accordingly, e.g., marked, at the core, allowing the core to proceed with CC-Mem-Op-syncs. The same mechanism that is used to track other CC-Mem-Ops and/or CC-fences may be used with the IC-fence instruction.

At the completion level, the memory controller ensures that any memory operation ordered after the IC-fence in program-conflict order may not bypass another memory operation that was ordered before the IC-fence on its path to memory. For example, according to an embodiment, the memory controller ensures that memory operations ordered after the IC-fence instruction that access the same address as an instruction ordered prior to the IC-fence instruction are not reordered before the IC-fence instruction.

A. Ordering Tokens

According to an embodiment, ordering tokens are used to enforce ordering of memory operations at components in the memory pipeline, cause one or more memory controllers at the completion level to issue ordering acknowledgment tokens, and by cores to track IC-fences. Ordering tokens may be implemented by any type of data, such as an alphanumeric character or string, code, etc.

When an IC-fence is used to provide ordering between uncached MC-Mem-Ops and un-cached CC-Mem-Ops (FIG. 2A) or between un-cached MC-Mem-Ops (FIG. 2C) and an IC-fence instruction is issued by a core C1, an ordering token T1 is tagged with the completion level, e.g., a memory side cache, in-DRAM PIM etc., specified by the IC-fence instruction and inserted into the memory pipeline. For example, the metadata for the ordering token T1 may specify the completion level from the IC-fence instruction. The ordering token T1 flows down the same memory pipeline as any prior memory operations from core C1 that it is meant to order until the ordering token reaches the completion-level. For example, if the IC-fence instruction is defined to order prior MC-Mem-Ops (FIGS. 2A, 2C) and the MC-Mem-Ops bypass caches, the ordering token T1 also bypasses the caches and flows to the completion level of the MC-Mem-Ops. According to an embodiment, the ordering token T1 does not flow below the completion level. For example, if the completion level is memory-side cache, the ordering token T1 does not flow past the memory-side cache to main memory.

Throughout the memory pipeline, memory components, such as cache controllers, memory-side cache controllers, memory controllers, e.g., main memory controllers, etc., ensure the ordering of memory operations so that memory operations ahead of the ordering token T1 do not fall behind the ordering token T1, for example because of reordering. According to an embodiment, the processing logic of memory components is configured to recognize ordering tokens and enforce a reordering constraint that prevents the aforementioned reordering with respect to the ordering token T1. In architectures that use path diversity, i.e., multiple paths, to the completion level associated with the IC-fence (multiple slices of a memory-side cache or multiple memory controllers), the ordering token T1 is replicated over each of these paths. For example, components at memory pipeline divergence points may be configured to replicate the ordering token T1.

According to an embodiment, network traffic attributable to replicating ordering tokens because of path diversity is reduced using status tables. At path divergence points, status tables track the types of memory-centric operations that have passed through the divergence points. If a memory-centric operation has not been issued on a particular path from the issuing core of the same type as the most recent IC-fence operation from the same core, then the ordering token T1 is not replicated on the particular path and instead an implicit ordering acknowledgment token T2 is generated for the particular path. This avoids issuing an ordering token T1 that is less likely to be needed, thereby reducing network traffic. The status tables may be reset when the ordering acknowledgment token T2 is received.

Once the ordering token T1, and any replicated versions of ordering token T1, reach the completion level associated with the ordering token T1, the ordering token T1 is queued in the structure that tracks pending memory operations at the completion level, such as a memory controller queue. According to an embodiment, a memory controller uses the completion level of the ordering token T1, e.g., by examining the metadata of the ordering token T1, to determine whether an ordering token has reached the completion level. The ordering token T1 is not provided to components in the memory pipeline beyond the completion level. For example, for an ordering token having an associated completion level of memory-side cache, the ordering token is not provided to a main memory controller.

If multiple such structures exist, such as multiple bank queues, the ordering token T1 is replicated at each of these structures. Any re-ordering of memory operations that is performed on these structures preserves the ordering of the ordering token T1 by ensuring that no memory operations after the ordering token T1 are re-ordered before the ordering token T1, with respect to memory operations preceding the ordering token T1. For example, according to an embodiment, the memory controller ensures that memory operations ordered after the ordering token T1 that access the same address as an instruction ordered prior to the ordering token T1 are not reordered before the ordering token T1. This may include performing masked address comparisons for operations that span multiple addresses such as multicast PIM operations. If a particular memory pipeline architecture supports aliasing, accesses traversing different paths on the way to memory, e.g., if there are separate queues for core-centric and memory-centric operations, then according to an embodiment reordering is prevented by propagating an ordering token along all possible paths and blocking a queue when an ordering token reaches the front of the queue. In this situation, the queue is blocked until the associated reordering token reaches the front of any other queue(s) that contain operations that may alias with this queue.

Once the ordering token T1 is queued at the completion level, an ordering acknowledgement token T2 is sent to the issuing core. For example, a memory controller at the completion level stores the ordering token T1 into its queue that stores pending memory operations and then issues an ordering acknowledgment token T2 to core C1. According to an embodiment, in case of path diversity, at each merge point order acknowledgment tokens T2 are merged on their path from the memory controller to the core.

The IC-fence instruction is deemed complete either on receiving ordering acknowledgement tokens T2 from all paths to the completion level or when a final merged ordering acknowledgment token T2 token is received by the core C1. In some implementations, there is a static number of paths and the core waits to receive an acknowledgment token T2 from all of the paths. Merged acknowledgment tokens T2 may be generated at each divergence point in the memory pipeline until a final merged acknowledgment token T2 is generated at the divergence point closest to the core C1. The merged ordering acknowledgment token T2 represents the ordering acknowledgement tokens T2 from all of the paths. Once the core C1 has received either all of the acknowledgment tokens T2 or a final merged acknowledgment token T2, the core C1 designates the IC-fence instruction as complete and continues committing subsequent memory operations.

According to an embodiment, ordering acknowledgment tokens identify an IC-fence instruction to enable a core to know which IC-fence instruction can be designated as complete when an ordering acknowledgment token is received. This may be accomplished in different ways that may vary depending upon a particular implementation. According to an embodiment, each ordering token includes instruction identification data that identifies the corresponding IC-fence instruction. The instruction identification data may be any type of data or reference, such as a number, an alphanumeric code, etc., that may be used to identify an IC-fence instruction. The memory controller that issues the ordering acknowledgment token includes the instruction identification data in the ordering acknowledgment token, e.g., in the metadata of the ordering acknowledgment token. The core then uses the instruction identification data in the ordering acknowledgment token to designate the IC-fence instruction as complete. In the prior example, when the core C1 generates the ordering token T1, the core C1 includes in the ordering token T1, or its metadata, instruction identification data that identifies the particular IC-fence instruction. When a particular memory controller at the completion level of the ordering token T1 stores the ordering token T1 into its pending memory operations queue and generates the ordering acknowledgment token T2, the particular memory controller includes the instruction identification data that identifies the particular IC-fence instruction from the ordering token T1 in the ordering acknowledgment token T2. When the core C1 receives the ordering acknowledgment token, the core C1 reads the instruction identification data that identifies the particular IC-fence instruction and designates the particular IC-fence instruction as complete. In embodiments where only a single IC-fence instruction is pending at any given time for each memory level the instruction identification data is not needed, and the memory level identifies which IC-fence instruction can be designated as completed.

This approach provides the technical benefits and effects of allowing cores to continue to use existing optimizations commonly employed with CC-fences to be employed with IC-fences. For example, core-centric memory operations, such as loads, that are subsequent to an IC-fence can be issued to the cache while the IC-fence instruction is pending via in-window speculation. As such, subsequent core-centric memory operations to an IC-fence instruction are not delayed but can be speculatively issued.

B. Level-Specific Cache Flushes

As previously described herein with respect to FIG. 2B, IC-fences may be used to provide proper ordering between CC-Mem-Ops and MC-Mem-Ops. There may be situations, however, where the results of the CC-Mem-Ops are stored in memory components, such as store buffers, caches, etc., that are before the coherence point and therefore not accessible to memory-side computational units, even though memory-side computational units need to use the results of the CC-Mem-Ops.

According to an embodiment, this technical problem is addressed by a technical solution that uses a level-specific cache flush operation to make the results of CC-Mem-Ops available to memory-side computational units. A level-specific cache flush operation has an associated memory-level, such as a memory-side cache, main memory, etc., that corresponds to the completion level of the synchronization. Dirty data stored in memory components before the completion level, e.g., core-side store buffers and caches, is pushed to the memory level specified by the level-specific cache flush operation. A programmer may specify the memory level for the level-specific cache flush operation based upon the memory level at which subsequent MC-Mem-Ops will be operating. For example, in FIG. 2B if the MC-Mem-Ops in step 7 will be operating on data in memory-side cache, then the level of the memory-side cache is specified for the level-specific cache flush. It should be noted that write-through caches (e.g., those used in GPUs) often already support primitives for flushing dirty data down to a specified coherence point—for our purposes, the operation must flush down to the completion point (which may be further than the coherence point).

In one embodiment, level-specific cache flush operations are tracked at the core until confirmation is received that the results of the CC-Mem-Ops, e.g., dirty data, that are currently stored in the memory components before the completion level have been stored to the associated memory level beyond the coherence point. When the confirmation is received, the core designates a level-specific cache flush operation as complete and proceeds to the next set of instructions. For example, in FIG. 2B, the level-specific cache flush in step 2 ensures that the results of the CC-Mem-Ops performed by Thread A in step 1 will be visible to Thread B.

In one embodiment, level-specific cache flush operations are tracked at the core until confirmation is received that the results of the CC-Mem-Ops, e.g., dirty data, have been flushed down to a specified cache level (write-back operations to the completion point are still in progress but not necessarily complete). In this case, the IC fence needs to prevent reordering of prior pending CC write-back requests triggered by this flush operation with itself at all cache levels below the specified cache level. This is in addition to the reordering it needs to prevent between prior MC requests and itself.

Level-specific cache flush operations may be implemented by a special primitive or instruction, or as a semantic to existing cache flush instructions. The memory-specific cache flush operation provides the technical effect and benefit of providing the results of CC-Mem-Ops to a particular memory level beyond the coherence point that may be before main memory, such as a memory-side cache, thus saving computational resources and time relative to a conventional cache flush that pushes all dirty data to main memory.

Level-specific cache flush operations may move all dirty data from all memory components before the completion level to the memory level associated with the level-specific cache flush operations. For example, all dirty data from all store buffers and caches is flushed to the memory level specified by the level-specific cache flush operation.

According to an embodiment, a level-specific cache flush operation stores less than all of the dirty data, i.e., a subset of the dirty data, from memory components before the completion level to the memory level associated with the level-specific cache flush operation. This may be accomplished by the issuing core tracking addresses associated with certain CC-Mem-Ops. The addresses to be tracked may be determined from the addresses specified by CC-Mem-Ops. Alternatively, the addresses to be tracked may be identified by hints or demarcations provided in a level-specific cache flush instruction. For example, a software developer may specify specific arrays, regions, address ranges, or structures for a level-specific cache flush and the addresses associated with the specific arrays or structures are tracked.

A level-specific cache flush operation then stores, to the memory level associated with the level-specific cache flush operation, only the dirty data associated with the tracked addresses. This reduces the amount of dirty data that is flushed to the completion point, which in turn reduces the amount of computational resources and time required to perform a level-specific cache flush and allows the core to proceed to other instructions more quickly. According to an embodiment, a further improvement is provided by performing address tracking on a cache-level basis, e.g., Level 1 cache, Level 2 cache, Level 3 cache, etc. This further reduces the amount of dirty data that is stored to the memory level associated with the level-specific cache flush operation.

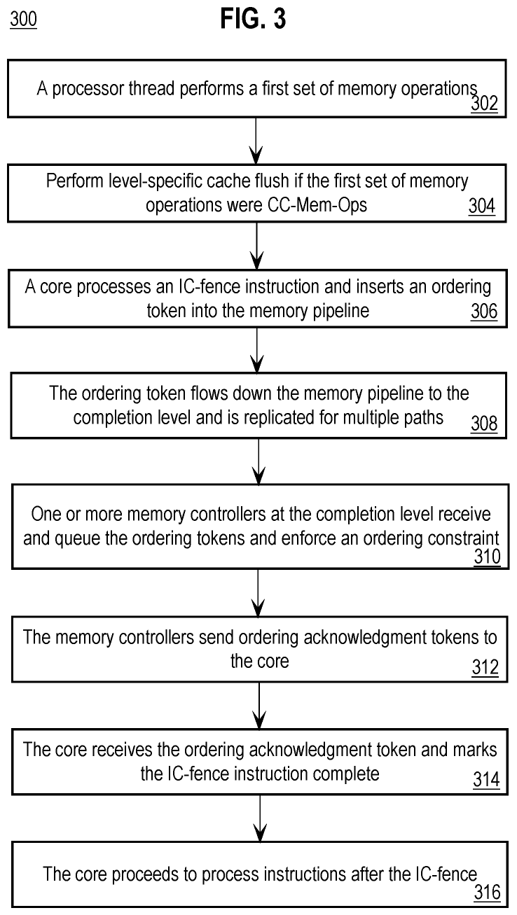

FIG. 3 is a flow diagram 300 that depicts an approach for enforcing ordering between memory-centric memory operations and core-centric memory operations using IC-fences. In step 302, a core thread performs a first set of memory operations. For example, the first set of memory operations may be MC-Mem-Ops or CC-Mem-Ops performed by Thread A in FIGS. 2A-2C. The CC-Mem-Ops/CC-Mem-Ops scenario of FIG. 2D is not considered in this example since that scenario does not use IC-fences.

After the first set of memory operations has been issued, in step 304 a level-specific cache flush operation is performed if the first set of memory operations were CC-Mem-Ops. For example, as depicted in FIG. 2B, Thread A includes instructions for performing a level-specific cache flush after the CC-Mem-Ops. The level selected for the level-specific cache flush is the memory level of instructions after an IC-fence. For example, in FIG. 1D, Thread B needs to be able to see the value of the flag written by Thread A. If the value of the flag written by Thread A is stored in cache, then the flag value needs to be flushed to a memory level accessible by the memory operations of Thread B. If those memory operations are MC-Mem-Ops, then the level for the level-specific cache flush is, for example, a level of memory-side cache or main memory. If the first set of memory operations were MC-Mem-Ops, as depicted in FIGS. 2A and 2C, then the level-specific cache flush operation of step 304 does not need to be performed.

In step 306, the core processes an IC-fence instruction and inserts an ordering token into the memory pipeline. For example, the instructions of Thread A include an IC-fence instruction which, when processed, causes an ordering token T1 with an associated completion level to be inserted into the memory pipeline. In step 308, the ordering token T1 flows down the memory pipeline and is replicated for multiple paths.

In step 310, one or more memory controllers at the completion level receive and queue the ordering tokens and enforce an ordering constraint. For example, a memory controller at the completion level stores the ordering token T1 into a queue that the memory controller uses to store pending memory operations. The memory controller enforces an ordering constraint by ensuring that memory operations ahead of the ordering token T1 in the queue are not reordered behind the ordering token T1, and that memory operations that are behind the ordering token T1 in the queue are not reordered ahead of the ordering token T1.

In step 312, the memory controllers at the completion level that queued the ordering tokens issue ordering acknowledgment tokens to the core. For example, each memory controller at the completion level issues an ordering acknowledgment token T2 to the core in response to the ordering token T1 being queued into the queue that the memory controller uses to store pending memory operations. According to an embodiment, the ordering acknowledgement token T2 includes instruction identification data that identifies the IC-fence instruction that caused the ordering token T1 to be issued. Ordering acknowledgment tokens T2 from multiple paths may be merged to create a merged ordering acknowledgment token.

In step 314, the core receives the ordering acknowledgment tokens T2 and upon either receiving the last ordering acknowledgment token T2, or a merged ordering acknowledgment token T2, designates the IC-fence instruction as complete, e.g., by marking the IC-fence instruction as complete. While waiting to receive the ordering acknowledgment token(s) T2, the core does not process instructions beyond the IC-fence instruction, at least not on a non-speculative basis. This ensures that instructions before the IC-fence are at least scheduled at the memory controllers at the completion level before the core proceeds to process instructions after the IC-fence.

In step 316, the core proceeds to process instructions after the IC-fence. In FIGS. 2A-2C, the CC-Mem-Op-sync is performed, for example to set the value of a flag, as previously discussed with respect to FIG. 1D, which then allows the CC-fence instruction and the subsequent CC-Mem-Ops (FIG. 2A) or MC-Mem-Ops (FIGS. 2B, 2C) to be performed.

1. A processor configured to:
in response to an ordering instruction, issue an ordering token that has an associated completion level in a memory system,
receive an ordering acknowledgment token that was issued by a memory component at the associated completion level in the memory system that processed the ordering token, and
in response to the ordering acknowledgment token, designate the ordering instruction as complete.

2. The processor of claim 1, wherein the associated completion level is the same as a completion level of one or more preceding memory operations.

3. The processor of claim 1, wherein one or more memory components in a memory pipeline prevent memory operations ahead of the ordering token from being reordered behind the ordering token.

4. The processor of claim 1, wherein the ordering token is replicated over a plurality of paths in a memory pipeline.

5. The processor of claim 1, wherein the memory component is a memory controller, a cache controller, or a memory-side cache controller.

6. The processor of claim 1, wherein the ordering acknowledgment token is issued by the memory component in response to the memory component storing the ordering token in a queue that stores pending memory operations.

7. The processor of claim 1, wherein the ordering acknowledgment token is a last ordering acknowledgment token of a plurality of replicated ordering acknowledgment tokens or a merged ordering acknowledgment token that represents the plurality of replicated ordering acknowledgment tokens.

8. The processor of claim 1, wherein the processor is further configured to:
issue the ordering token in response to processing the ordering instruction, and enforce a memory operation reordering constraint with respect to the ordering instruction.

9. The processor of claim 1, wherein the processor is further configured to prior to issuing the ordering token, cause updated data stored in a memory location before a completion point to be stored to a specified completion level.

10. The processor of claim 9, wherein the updated data is a subset of data generated by one or more prior memory operations.

11. A memory controller configured to:
enforce an ordering constraint based upon an ordering token, and
issue an ordering acknowledgment token to a processor thread that issued the ordering token.

12. The memory controller of claim 11, wherein enforcing the ordering constraint based upon the ordering token includes preventing one or more memory operations ordered after the ordering token from being reordered before the ordering token.

13. The memory controller of claim 11, wherein enforcing the ordering constraint based upon the ordering token includes preventing one or more memory operations ordered after the ordering token for a same memory address as a memory operation before the ordering token from being reordered before a memory operation before the ordering token to the same address.

14. The memory controller of claim 11, wherein the ordering acknowledgment token is issued to the processor thread that issued the ordering token in response to the ordering token being stored in a pending memory operations queue for the memory controller.

15. The memory controller of claim 11, wherein the memory controller is one or more of a cache controller, a memory-side cache controller, or a main memory controller.

16. A method comprising:
issuing, by a processor, an ordering token that has an associated completion level in a memory system, and
designating, by the processor, an ordering instruction as complete in response to an ordering acknowledgment token that was issued by a memory component, at the completion level in the memory system, that processed the ordering token.

17. The method of claim 16, wherein the associated completion level is the same as a completion level of one or more preceding memory operations.

18. The method of claim 16, wherein one or more memory components in a memory pipeline prevent memory operations ahead of the ordering token from being reordered behind the ordering token.

19. The method of claim 16, wherein the ordering token is replicated over a plurality of paths in a memory pipeline.

20. The method of claim 16, wherein the memory component is a memory controller, a cache controller, or a memory-side cache controller.
